(19) United States
(12) Patent Application Publication
(10) Pub. No.: US 2007/0074177 A1
(43) Pub. Date: Mar. 29, 2007

(54) Logic extraction support apparatus

(75) Inventors: Shigeru Kurita, Yokohama (JP); Hirofumi Shinke, Yokohama (JP); Kazuyuki Aoyama, Akishima (JP); Takashi Kashimoto, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/496,888

(22) Filed: Jul. 31, 2006

(30) Foreign Application Priority Data
Sep. 29, 2005 (JP) 2005-283261

(51) Int. Cl. G06F 9/44

(52) U.S. Cl. 717/131; 717/127

(57) ABSTRACT

In extracting logic by backward slice, all logic portions influencing an output start point are extracted and the extraction result contains logic not necessary for a user. In order to solve this, a user is made to designate input information on logic to be extracted from a program constituting an already existing system, and it is judged whether it is necessary to extract specific logic of each command statement of the program. Extraction necessity of specific logic from an analysis subject program is classified as follows. A command statement influenced by only an input designated by a user is classified into a command statement to be extracted, a command statement influenced by both an input designated by the user and an input not designated by the user is classified into a command statement to be corrected, and a command statement influenced by only an input not designated by the user is classified into a command statement not to be extracted.

### BACKGROUND OF THE INVENTION

1. Field of the Invention

The present invention relates to techniques of analyzing a program used in an information system and extracting logic designated by a user, and more particularly to program slice techniques.

2. Description of the Related Art

A program slice technique is conventionally known as the technique of using start point information on a program to extract a portion of the program which influences the start point or is influenced by the start point. This program slice technique has recently drawn attention as the technique capable of extracting logic designated by a user from a program constituting an already existing system (legacy system).

With this technique, relations between command statements in a program are collected in a graph called a dependency graph, and a command statement, which influences a command statement designated as a start point or is influenced by the start point, is extracted from the dependency graph. According to the program slice, relations between command statements are classified into two relations: a data dependency relation and a control dependency relation. Data dependency indicates the relation that data referred to by a command statement is referred by another command statement, and control dependency indicates the relation that an execution condition of a command statement is controlled.

Methods of extracting particular program portions from the dependency graph include two methods: forward slice and backward slice methods. By the forward slice method, a command statement to be used as a start point of a slice process is selected, and the dependency graph is traced in the program execution order to thereby extract a command statement which is influenced by the start point.

By the backward slice method, a command statement to be used as a start point of a slice process is selected, and the dependency graph is traced in a reverse order of the program execution order to thereby extract a command statement which influences the start point.

A system for extracting logic (sub-routine) designated by a user from a program constituting a legacy system by using program slice is disclosed in JP-A-2005-18114. It is described that in this system, particular interface information is selected and program slice is executed starting from the selected particular interface information, so that a command statement related to the information can be extracted.

### SUMMARY OF THE INVENTION

If a program containing a function desired to be extracted by a user is identified and a logical input and a logical output of this function are known to some extent, the extraction result of logic desired by the user can be considered as logic which calculates an output designated by the user only from an input item designated by the user. This situation frequently occurs when a legacy system is reproduced or in other cases.

Although it is insisted that the system of JP-A-2005-18114 can extract logic designated by a user from a program by executing program slice from an item designated by the user, a specific method is not described at all. Therefore, essential issues are not settled which occur when program slice is adopted for logic extraction, for example, logic necessary for program execution cannot be extracted when logic extraction is executed by adopting forward slice, and a result of logic extraction by adopting backward slice contains a command statement not necessary for the user.

By using this method, if a user extracts or generates an output intended by a user from only an input intended by the user, it is necessary to understand the extracted logic and correct the logic in order to eliminate the influence by inputs not designated by the user. There may arise issues that it takes time to identify the correction location and that a correction location is wrong.

According to the present invention, a user is made to designate input information regarding logic to be extracted from a program constituting an already existing system, and extraction necessity of specific logic is judged for each command statement of the program. Extraction necessity of specific logic from an analysis subject program is classified as follows. A command statement influenced by only an input designated by a user is classified into a command statement to be extracted, a command statement influenced by both an input designated by the user and an input not designated by the user is classified into a command statement to be corrected, and a command statement influenced by only an input not designated by the user is classified into a command statement not to be extracted. Each classified command statement is displayed in a distinguished manner. A user may designate not only an input start point but also an output start point to thereby narrow a logic extraction range.

Classified command statements used as the extraction subject, command statements necessary for judgement and command statements not used as the extraction subject are displayed for a user by using a display unit or the like. Correction portions for extracting logic designated by a user are presented to support the user to execute a procedure of extracting designated logic from an already existing system.

According to the system of the present invention, it is possible to extract or generate logic for calculating a user-designated output from a user-designated input, while an already existing program is referred to.

### BRIEF DESCRIPTION OF THE DRAWINGS

FIG. 1 is a block diagram showing the overall structure of a system according to an embodiment of the invention.

FIG. 2 is a flow chart illustrating the function of a control part 130.

FIG. 3 is a flow chart illustrating a specific logic extraction function of Step 203.

FIG. 4 is a flow chart illustrating the details of a logic extraction process.

FIG. 5 is a flow chart illustrating the details of a necessary logic judgement process.

FIG. 6 is an ER diagram showing a relation between tables.

FIG. 7 shows a program to be analyzed in the embodiment.

FIG. 8 is a command statement information table for storing programs to be analyzed, in a command statement unit.

FIG. 9 is a command statement information table after a specific logic extraction function is executed.

FIG. 10 is a word information table for storing programs to be analyzed, in a command word unit.

FIG. 11 is a word information table after a specific logic extraction function is executed.

FIG. 12 is a control dependency information table for managing command statement numbers added to command statements which are dependency sources and destinations of control dependency.

FIG. 13 is a data dependency information table for managing command statements which are dependency sources and destinations of data dependency, and data items of the command statements.

FIG. 14 is a dependency graph collecting analysis results shown in FIG. 7.

FIG. 15 is a flow chart illustrating a logic extraction process for an analysis subject program containing a loop.

FIG. 16 is a flow chart illustrating a loop evaluation function.

FIG. 17 is a flow chart illustrating a trial-and-error process.

FIG. 18 shows a program containing a loop, the embodiment being described using this program.

FIG. 19 is a command statement information table immediately before loop evaluation is made.

FIG. 20 is a command statement information table immediately before the trial-and-error process is executed.

FIG. 21 is a control dependency information table after the specific logic extraction process is executed for a program containing a loop.

FIG. 22 is a word information table before specific logic extraction.

FIG. 23 is a word information table after specific logic extraction.

FIG. 24 is a control dependency information table registering program information shown in FIG. 7.

FIG. 25 is a data dependency information table registering program information shown in FIG. 7.

FIG. 26 is a dependency graph collecting program information showing in FIG. 7.

FIG. 27 is a menu screen to be used for explaining the function of the control part 130.

FIG. 28 is a screen for displaying correction support information in a command statement unit.

FIG. 29 is a screen for displaying extraction support information in a data item unit.

FIG. 30 is a screen for receiving program correction from a user.

### DESCRIPTION OF THE EMBODIMENT

Embodiments of the present invention will be described.

[First Embodiment]

The first embodiment of the present invention will be described in detail with reference to the accompanying drawings.

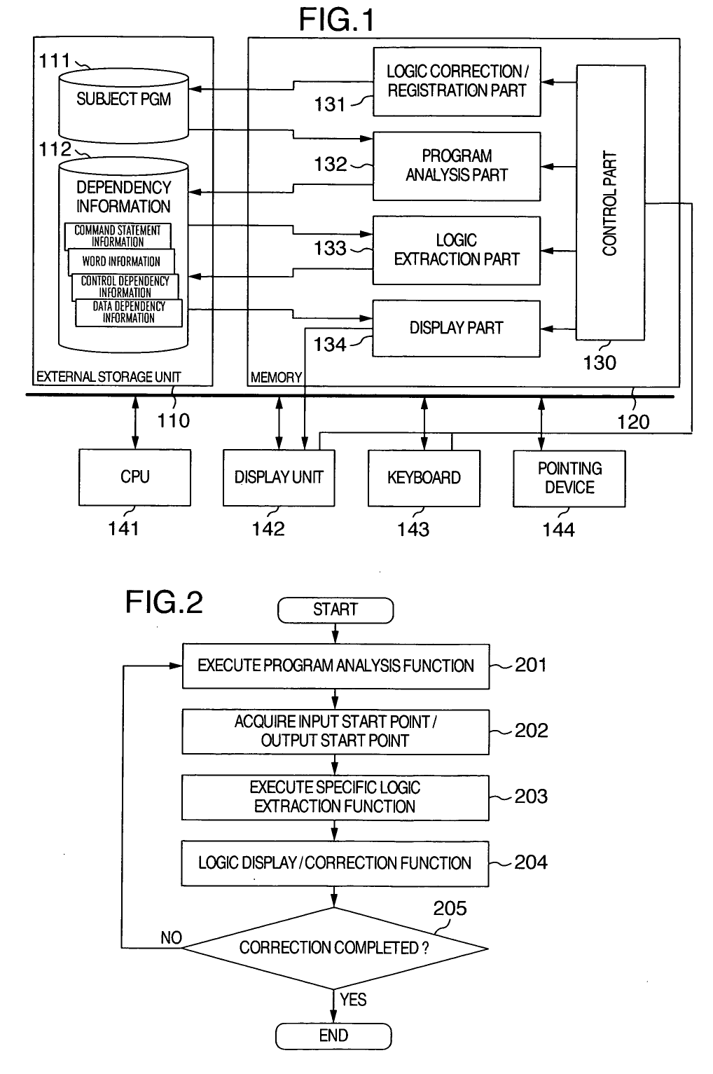

FIG. 1 is a diagram showing the overall structure of a logic extraction support system. The system is constituted of a CPU 141, a display unit 142, a keyboard 143, a pointing device 144 such as a mouse, a memory 120 and programs 131 to 134 stored in the memory, respectively interconnected by a connection means such as a bus. Reference numeral 110 represents an external storage unit, and reference numerals 111 and 112 represent data stored in disks. A subject program 111 is a set of programs to be analyzed by the system of the present invention and a set of programs corrected by the system.

With reference to a flow chart of FIG. 2, description will be made on the function of a control part of the logic extraction support system. A user designates a function to be executed, and the control part executes the designated function by using functions 131 to 134.

A program analysis part 132 shown in FIG. 1 searches a program set 111 to be analyzed, by using as a search key a program name designated by a user from the keyboard 143 and pointing device 144, and acquires the program to be analyzed (Step 201).

Next, a user is made to designate an input start point and an output start point to be used as start points of logic extraction, and the start point information is supplied to the logic extraction part 133 (Step 202).

Next, a specific logic extraction function is executed to classify command statements into: command statements to be extracted; correction candidate command statements; and command statements not to be extracted, and resisters these command statements as the logic extraction result 112. The specific logic extraction function 203 will be described later in detail (Step 203).

The display part 134 acquires the dependency information stored in the external storage device 112, and classifies the dependency information into: command statements to be extracted; correction candidate command statements; and command statements not to be extracted, and displays these command statements on the display unit 142. A user is made to correct the program from the keyboard 143, relative to the logic extraction result displayed on the display unit 142. The logic correction/registration part 131 acquired the correction result registers the corrected program as an analysis subject source (Step 204).

Steps 201 to 204 are repeated until the program correction is completed, and the system is terminated when there is no correction candidate command statement in the program.

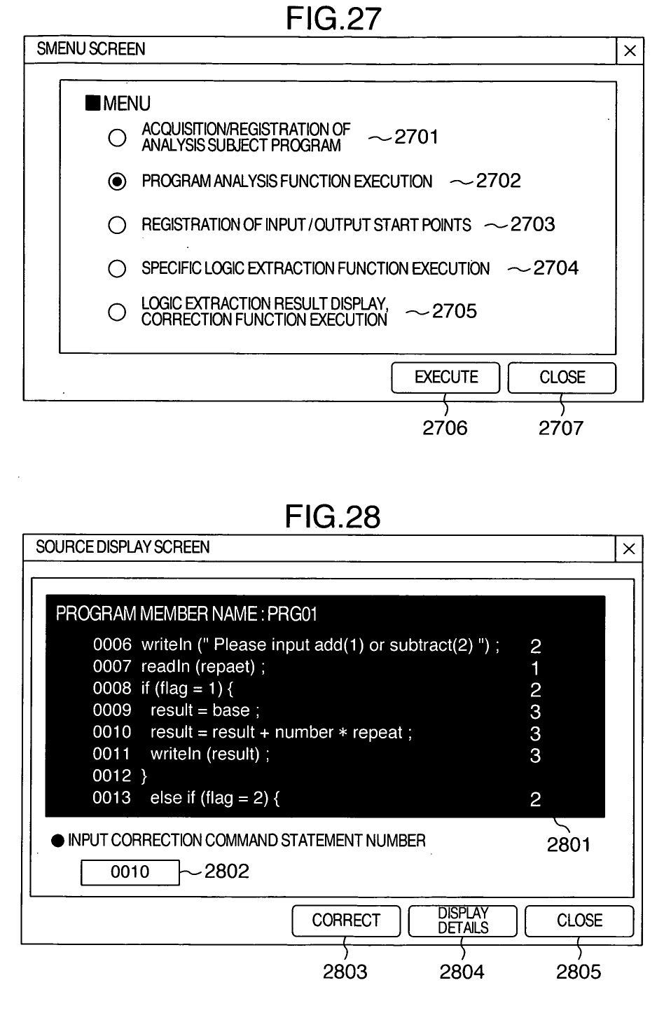

Next, with reference to the menu screen shown in FIG. 27, the function of the control part will be described specifically. First, a user is made to select “acquisition/registration of analysis subject program” 2701 to acquire an analysis subject program from the external storage device 111.

After the analysis subject program is acquired, the user is made to select a “program analysis function” 2702 to activate the program analysis part 132, generate dependency information and register the dependency information in the dependency information disk 112. The dependency information is information stored in a command statement information table 601, a word information table 602, a control information table 603, and a data dependency information table 604. These tables will be later described in detail.

Next, the user is made to select “registration of input/output start points” 2703 to call an input/output registration screen, and the user is made to register an input data item from this screen. The registered input information is registered in the word information table 602. When an input start point is acquired, output start point information may be acquired in order to narrow a logic extraction range.

After the input/output start points are registered, the user is made to select “specific logic extraction function execution” 2704 to execute the logic extraction part 133, and in accordance with this execution result, the command statement table 601 and word information table 602 storing the dependency information are updated.

If the extraction result is to be displayed after the specific logic is extracted, the user is made to select “logic extraction result display/correction execution” 2705 to activate the display part 134 and display the extraction result on a source display screen shown in FIG. 28. If there is a logic correction candidate command statement, the user is prompted to correct the program from the logic correction screen shown in FIG. 30, and the correction result is registered in the subject program disk 111 as the analysis subject program.

After the source is displayed on the source display screen of FIG. 28, if the user judges that it is not necessary to correct the logic, the user depresses a close button 2707 to store the final logic extraction result in the subject program disk 111.

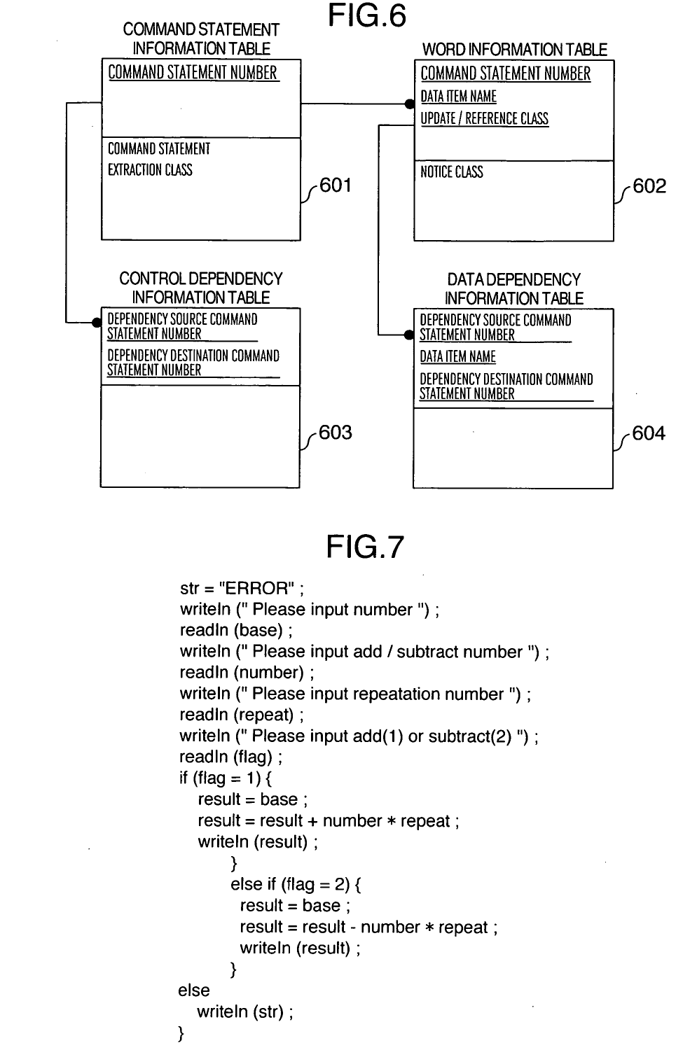

Next, the external storage device will be described. The subject program disk 111 stores the program to be analyzed and the program corrected by the user from the logic correction screen shown in FIG. 30, and the dependency information disk 112 stores the tables shown in FIG. 6.

These tables will be described. The command statement table 601 registers analysis subject programs in a command statement unit, and the word information table 602 registers the analysis subject program in a record in a data item unit. The control dependency information table 603 registers a relation between a conditional statement and a command statement controlled by the conditional statement, and the data dependency information table 604 registers a relation between a command statement updating a data item and a command statement referring to the data item. Lines interconnecting these tables in FIG. 6 indicate relations between these tables.

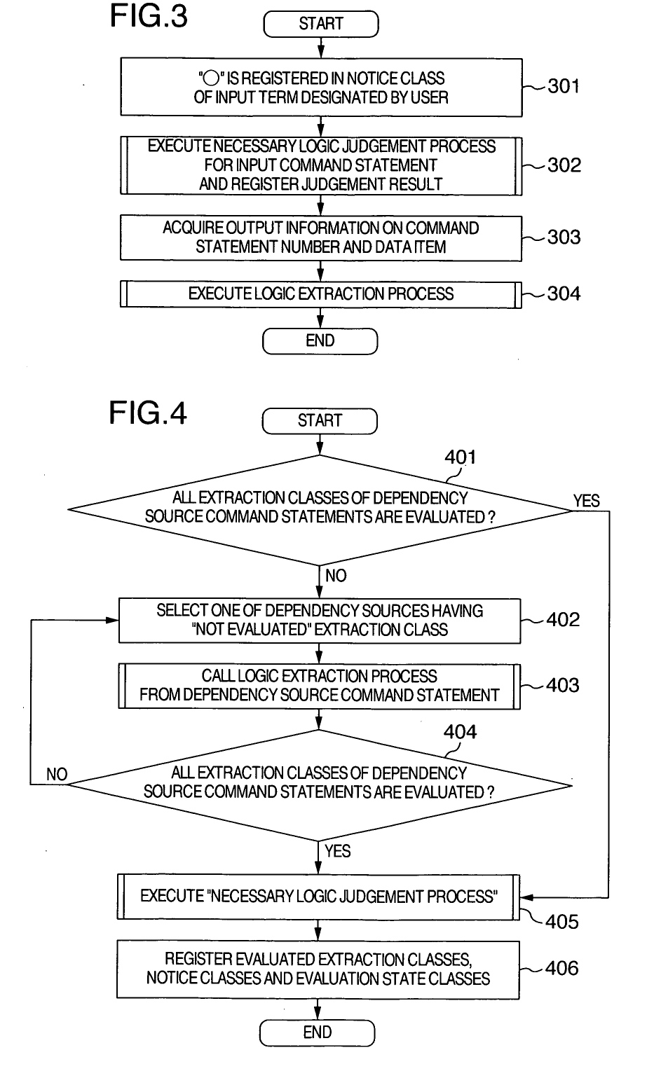

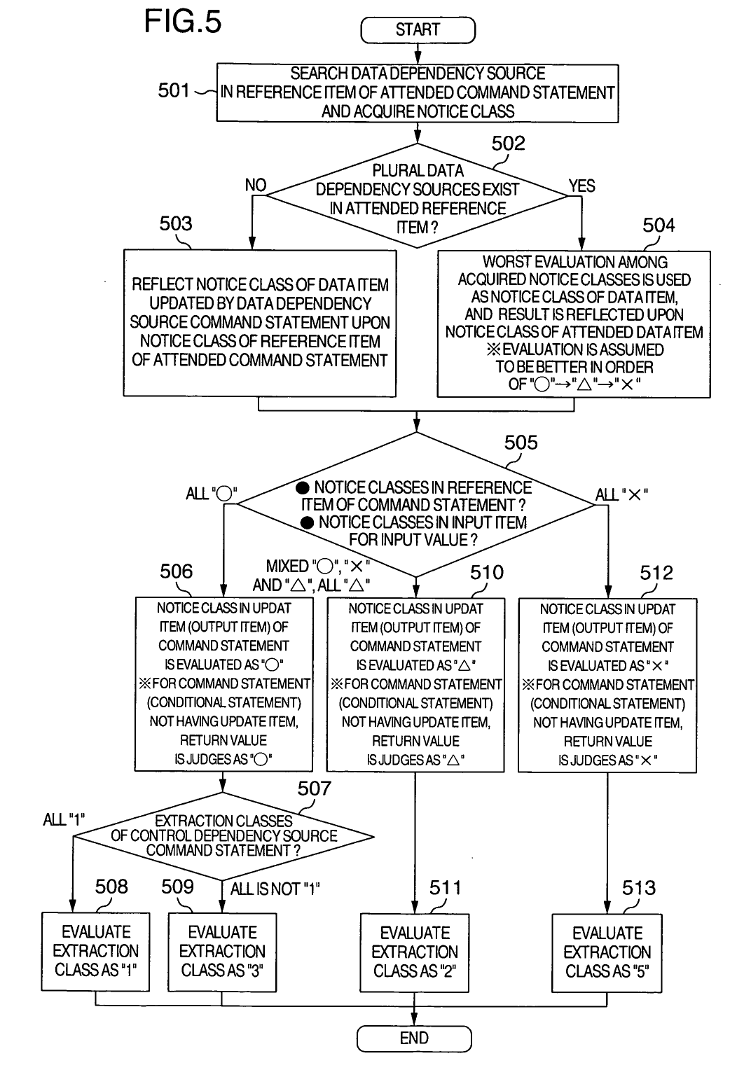

Next, description will be made on the overall flow chart of FIG. 3 illustrating the specific logic extraction function. The flow chart of FIG. 4 illustrates the logic extraction process which is a subroutine of the specific logic extraction function and the flow chart of FIG. 5 illustrates a necessary logic judgement process. These flow charts illustrate the details of Step 203.

The specific logic extraction function 203 classifies the analysis subject program into: command statements and data items influenced only by input information designated by a user; command statements and data items influenced by input information not designated by the user; and command statements and data items influenced by input information both designated and not designated by the user, in accordance with the dependency information 112 and input/output information designated by the user. A command statement influenced by input information designated by the user may be classified into the command statement influenced only by the input information designated by the user.

First, description will be made on the outline of the flow chart of FIG. 3. Of records of the work information table 602, “◯” is registered in a notice class of the record registering the command statement number and data item name designated as an input start point, and “×” is registered in the notice class of other input items (Step 301).

Next, the necessary logic judgement process shown in FIG. 5 is executed, and the evaluation result is registered in an extraction class of the record registering the command statement at the input start point among the records of the command statement information table 601 (Step 302).

Output start point information is acquired which is a set of an output command statement and an output data item designated by a user (Step 303).

The logic extraction process 304 is executed to evaluate the extraction class and notice class of the command statement and data item influencing the output start point (Step 304).

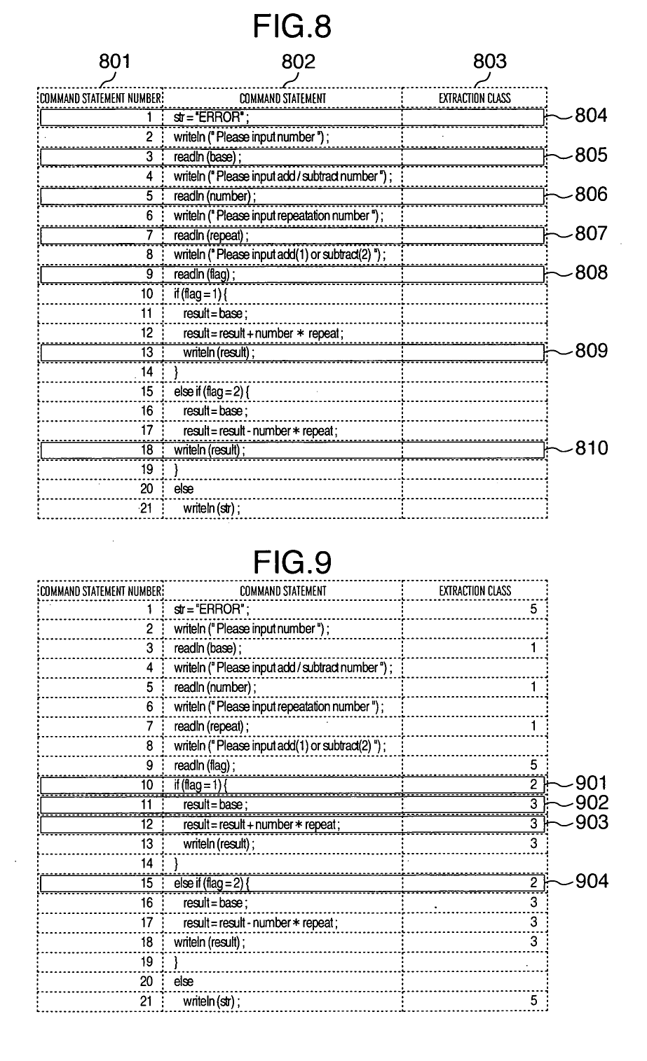

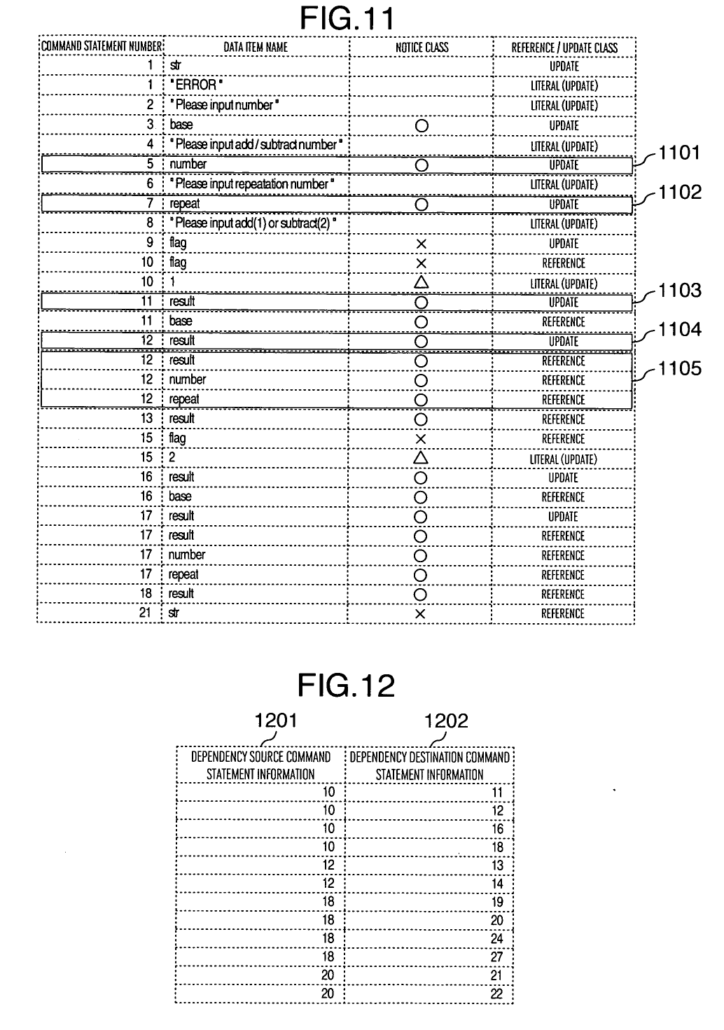

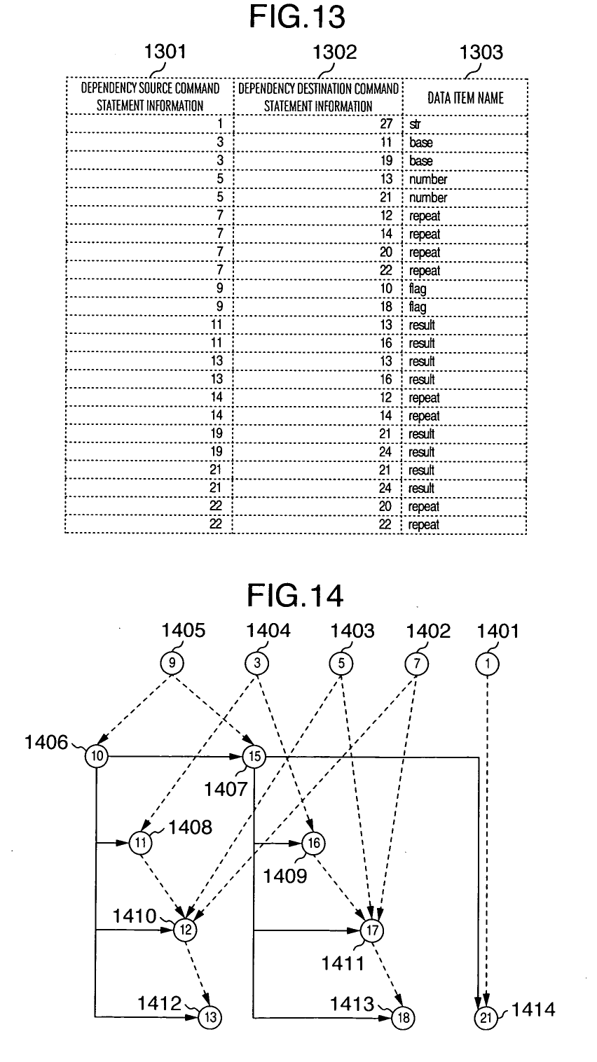

Description will be made on the flow chart of FIG. 3 by using as an example a logic extraction process for the program shown in FIG. 7. First, description will be made on each table used by the logic extraction function and data items constituting each table. FIGS. 8, 10, 12, 13 and 14 show a command statement information table, a word information table, a control dependency information table, a data dependency table and a dependency graph, respectively generated by executing the program analysis function 201. The dependency graph of FIG. 14 is a graph combining the control dependency relation of FIG. 12 and the data dependency relation of FIG. 13. Broken lines in FIG. 14 indicate data dependency and solid lines indicate control dependency.

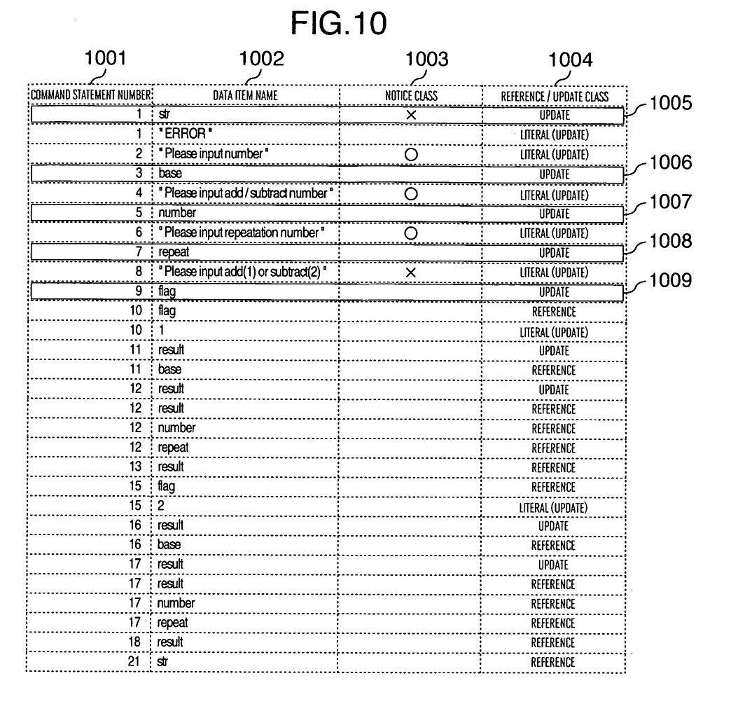

Next, data items of each table will be described. Each command statement number is registered in a command statement number 801 of the command statement information table of FIG. 8, and an analysis subject program is registered in a command statement 802 in a command statement unit. An evaluation result of the necessary logic judgement process to be later described is registered in an extraction class 803. “1” is registered in the extraction class for the command statement evaluated as an extraction subject, “2” is registered for the command statement requiring correction for extraction, “3” is registered for the command statement if the conditional statement of a control dependency source is the extraction subject, and “5” is registered for the command statement not used as the extraction subject. Next, the data item in the word information table shown in FIG. 10 will be described.

The same command statement number as that registered in the command statement information table is registered in a command statement number 1001 in a data item unit, and an analysis subject program divided in the date item unit is registered in a data item name 1002. An evaluation result of a data item by the necessary logic judgement process to be described later is registered in a notice class 1003. “◯” is registered for a data item evaluated as an extraction subject, “Δ” is registered for a data item not used as the extraction subject, and “×” is registered for a data item updated in the command statement. “Reference” is registered in a reference/update class 1004 if the registered data item refers to another data item, and “update” is registered for a data item updated in the command statement. A command statement number for a control dependency source is registered in a dependency source command statement number 1201 of the control dependency information table of FIG. 12, and a command statement number for a control dependency destination is registered in a dependency destination command statement number 1202. A command statement number for a data dependency source is registered in a dependency source command statement number 1301 of the data dependency information table of FIG. 13, and a command statement number for a data dependency destination is registered in a dependency destination command statement number 1303. Since it is assumed that the data item name of the data dependency source and destination does not change, a data item name for a data dependency subject is registered in a data item 1302.

In the following, concrete description will be made on a process of extracting specific logic from a program shown in FIG. 7. “◯” is registered in the notice class for word information 1006 to 1008 which is input start point information designated by a user, and “×” is registered in the notice class for the other input data items 1005 and 1009 (Step 301).

Next, the necessary logic judgement process shown in FIG. 5 is executed for each command statement, and evaluation results are registered in the extraction classes of the input command statements 804 to 808. Command statements 1402 to 1404 in a dependency graph of FIG. 14 indicate the command statements including the input start points designated by the user (Step 302).

Next, command information 809 and 810 is acquired which was designated by the user as the output start points. Command statements 1412 and 1413 in the dependency graph of FIG. 14 are the command statements including the output start points designated by the user (Step 303).

After executing Step 303, the logic extraction process is executed to evaluate each command statement and each data item other than the input statements (Step 304). In the following, the details of the logic extraction process are described for each Step.

Each Step of the logic extraction process will be described with reference to the flow chart of FIG. 4. The logic extraction process is executed starting from the command statement at the output start point and it is confirmed whether the extraction class of the dependency source command statement of the output start command statement is evaluated, and if the extraction classes of all dependency source command statements are evaluated, the flow transits to Step 405, whereas if there is a dependency source command statement not evaluated, the flow transits to Step 402 (Step 401).

One arbitrary dependency source command statement is selected from dependency source command statements whose extraction class is confirmed to be not evaluated at Step 401 (Step 402).

The logic extraction process is recursively called from the dependency source command statement selected at Step 402 (Step 403). A recursive call of the logic extraction process 403 is repetitively executed at each command statement until a command statement arrives whose all dependency source command statements have extraction classes already evaluated.

If the command statement arrives whose dependency source extraction classes are already evaluated, the necessary logic judgement process is executed at Step 405 after the judgement at Step 401. The necessary logic judgement process will be later described with reference to the flow chart of FIG. 5. The necessary logic judgement process evaluates the extraction class of an attended command statement (Step 405).

Information on the extraction class and notice class evaluated at Step 405 is registered in the command statement information table 601 and word information table 602 to thereafter terminate the logic extraction process called from the attended command statement (Step 406).

After the logic extraction process is terminated, an attended point by the system transits to the logic extraction process called immediately before the terminated logic extraction process. Namely, at the same time when the logic extraction process is terminated, the attended point transits to the logic extraction process called from the dependency destination command statement.

As the attended point transits to the logic extraction process called from the dependency destination command statement, the logic extraction process resumes from Step 404 because the process was stopped when the logic extraction process is called at Step 403.

It is confirmed at Step 404 whether all the extraction classes of the dependency command statements of the attended command statement are evaluated. If the extraction classes of all the dependency command statements are evaluated, the flow transits to Step 406, whereas if there is a dependency source command statement still not evaluated, the flow transits to Step 402. The above processes are repeated until all logic extraction processes called from command statements are completed.

Next, with reference to the dependency graph shown in FIG. 14, concrete description will be made on the process of extracting logic from the program shown in FIG. 7.

If a user designates the command statement 1413 as the output start point, it is possible, by checking the dependency command statements, to judge that the extraction classes of the command statements 1407 and 1411 are still not evaluated (Step 401).

One attended command statement is selected from the command statements 1411 and 1407 (Step 402).

If the command statement 1411 is selected at Step 402, the logic extraction process is recursively called from the command statement 1411 (Step 403).

The process at Step 403 is again called from the command statement 1411 and executed to judge whether all the extraction classes of the dependency source command statements of the command statement 1411 are evaluated (Step 404-2).

Although the dependency source command statements 1402, 1403 and 1409 exist, “1” is already registered in the extraction classes of the dependency command statements 1402 and 1403, and the logic extraction process is called from the dependency source command statement 1409 still not evaluated (Steps 402-2, 403-2).

The above-described processes are repeated until the command statement arrives whose all dependency source command statements have extraction classes already evaluated. Therefore, the logic extraction process is called for each traced dependency source command statement.

In the example described above, at the time when the command statement 1406 is traced, the extraction classes of all dependency source command statements are evaluated. Therefore, at this time the necessary logic judgement process to be described later is executed to evaluate the attended command statement 1406. At the same time, the data item contained in the command statement 1406 is evaluated.

Evaluation results of the extraction class of the command statement 1406 and the notice class of the data item thereof are registered in the command statement information table of FIG. 8 and the word information table of FIG. 10, and thereafter, the logic extraction process called from the command statement 1406 is terminated. As the logic extraction process called from the command statement 1406 is terminated, the attended point becomes the command statement 1407, and the logic extraction process called from the command statement 1407 is executed at Step 404.

First, the extraction classes of the dependency source command statements 1405 and 1406 of the attended command statement 1407 are acquired. Since all the extraction classes of the dependency source command statements of the command statement 1407 are evaluated, the necessary logic judgement process shown in FIG. 4 evaluates the extraction class and data item of the command statement 1407, and the evaluation results are registered in the command statement information table of FIG. 8 and the word information table of FIG. 12. As the logic extraction process called from the command statement 1407 is terminated, the attended command statement transits from 1407 to 1409. As described above, the logic extraction process called from each command statement is sequentially terminated, and when all the extraction classes and notice classes for the output start point are decided, the process of the specific logic extraction function at Step 203 is terminated.

(Necessary Logic Judgement Process)

FIG. 5 is a flow chart illustrating the necessary logic judgement process. This process evaluates the extraction class of the attended command statement and the notice class of the update data item in the command statement. Each Step of the flow chart will be described below.

A data dependency source in a reference item of the attended command statement is searched to acquire the notice class of the data dependency source (Step 501).

Next, the process at Step 504 is executed if there are a plurality of data dependency sources in the attended reference item, whereas if a plurality of data dependency sources do not exist, the acquired notice class is reflected upon the notice class of the attended reference item (Steps 502, 503).

If there are a plurality of data dependency sources in the attended reference item, the evaluation of the notice class among the acquired notice classes remotest from the extraction subject is used as the evaluation of the data item, and stored in the word information table (Step 504). The evaluation of the notice class is assumed to be remoter from the extraction subject in the order of “◯”→“Δ”→“×”.

If it is judged that the notice classes in the reference item of the attended command statement are all “◯”, the flow transits to Step 506 (Step 505).

First, if “◯” is registered in all notice classes in the reference item of the attended command statement, “◯” is given also to the update item. If the attended command statement is a conditional statement and has no update item, the notice class may be given virtually to the return value of the conditional statement. (Step 506)

For the command statement having “◯” in the update item or return value at step 506, the control dependency information table is searched by using the command statement number to acquire the extraction class of the control dependency source command statement (Step 507).

If all control dependency source command statements are “1” or there is no control dependency source command statement, “1” is registered in the extraction class of the attended command statement (Step 508).

If a numerical value other than “1” is registered in the extraction class of the control dependency source command statement, “3” is registered in the extraction class of the attended command statement (Step 509).

If it is judged at Step 505 that two or more of “◯”, “Δ” and “×” are mixed in the notice classes in the reference item of the command statement or that only “Δs” are registered, “Δ” is given to the update item. If the attended command statement is a conditional statement and has no update item, the notice class “Δ” may be added virtually to the return value of the conditional statement. (Step 510)

For the command statement whose update item or return value is added with “Δ” at Step 510, “2” is registered in the extraction class of the command statement information table (Step 511).

If it is judged at Step 505 that “×” is registered in the notice classes (e.g., all notice classes) in the reference item of the acquired command statement, “×” is given also to the update item. If the attended command statement is a conditional command statement and has no update item, the notice class “×” may be added to the return value of the conditional statement. (Step 512)

For the command statement whose update item or return value is added with “ ” at Step 512, “5” is registered in the extraction class of the command statement information table (Step 513).

Concrete description will be made on the necessary logic judgement process by illustratively using evaluation of the extraction class of command statement information 903 and evaluation of the notice class of word information 1104. By using the attended command statement number as a search key, the word information table is searched to acquire records 1105 whose reference/update class is reference.

As records 1101, 1102 and 1103 which are the data dependency sources of the word information 1105 are checked, it can be known that the dependency source is sole for all data items and “◯” is registered in the notice classes. Therefore, “◯” is registered in the notice classes of the word information 1105 (Steps 501 to 503).

Since “◯” is registered in all notice classes of the reference items 1105 constituting the command statement information 903, “◯” is registered also in the update item 1104 constituting the command statement information 1104 (Steps 505, 506).

Since the evaluation of the update items 1105 are completed, the command statement 903 containing-the reference items 1105 checks the extraction class of the control dependency source command statement. The command statement 903 searches the control dependency source command statement and acquires command statement information 901. Since “2” is registered in the extraction class, “3” is registered in the extraction class of the command statement information 903. (Step 509)

(Specific Logic Extraction Function when a Program Contains a Loop)

In the embodiment described above, an analysis subject program without a loop process is used as an example. If a program having a loop is to be analyzed, a specific processing is required. This is because as understood from the relation between command statements 2603 and 2605 of an analysis subject program having a loop process, dependency between the command statements in the loop process circulates so that evaluation cannot be determined.

In this embodiment, a command statement and a data item can be evaluated by executing the following process, similar to the program having no loop.

First, tables used by this process will be described. Similar to the program having no loop, the tables used by this process are four tables including a command statement information table 601, a word information table 602, a control dependency information table 603 and a data dependency information table 604. However, the command statement information table is different from a conventional command statement information table in that an evaluation state class 1901 and a trace start flag 1902 are registered. Of the added data items, the evaluation state class 1901 is input with an evaluation state of the extraction class of the attended command statement, and the trace start flag is added to a command statement which is used as the start point for determining the extraction class of a command statement with circulated dependency.

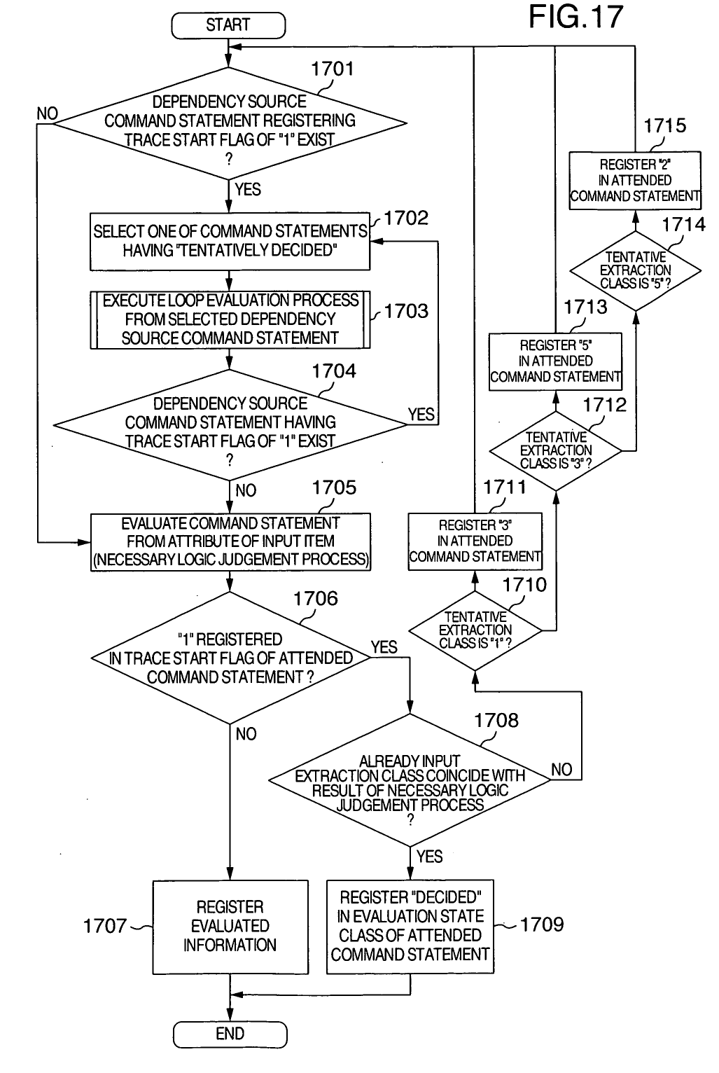

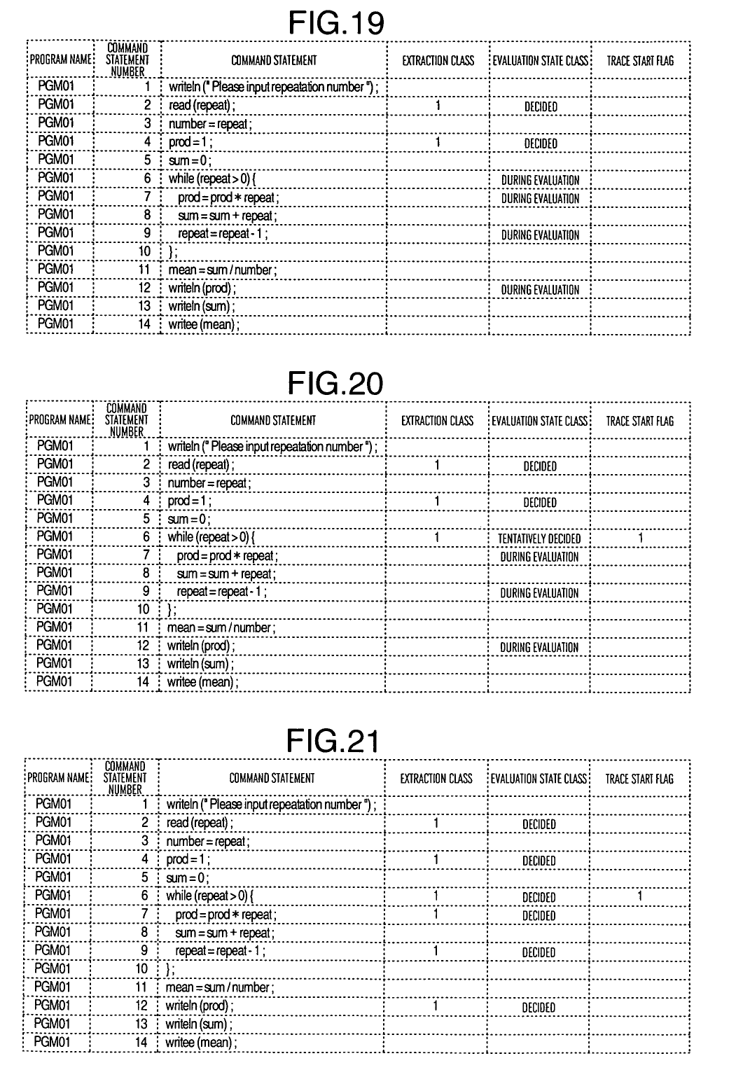

Description will be made on a process of analyzing a program having a loop by using these data models. The logic extraction process is executed to evaluate the command statement in a loop, by assuming one of “1” to “5” as the extraction class of the dependency source command statement of the attended command statement. For the command statement having a tentative value as the extraction class, it is confirmed whether the evaluation of the tentative command statement is coincident with the evaluation result by the necessary logic judgement process. If the evaluation of the tentative command statement does not coincide with the evaluation result by the necessary logic judgement process, another extraction class is assumed. This process is repeated until the tentative extraction class evaluation coincides with the evaluation by the necessary logic judgement process. The extraction classes at the time of coincidence are registered as decided extraction classes. It is therefore necessary to distinguish between a tentative value and a decided value of the evaluation state of the extraction class. As shown in the command statement information table in FIG. 19, the item of the evaluation state class is added to indicate the evaluation state of the extraction class. “During evaluation” is registered in the evaluation state class if evaluation of the extraction class is still not decided, “tentatively decided” is registered if the extraction class is the tentative value, and “decided” is registered if the extraction class has a decided value. When the necessary logic judgement process is executed, the evaluation state class is also evaluated. If “tentatively decided” is registered in the evaluation state class of the dependency source command statement, “tentatively decided” is also registered in the evaluation state class of the attended command statement, whereas if the evaluations of the evaluation state classes of the dependency source command statements are only “decided”, “decided” is also registered in the evaluation state class of the attended command statement. For the command statement whose dependency was detected, “1” is registered in the trace start flag to use the command statement as the start point of a loop evaluation process.

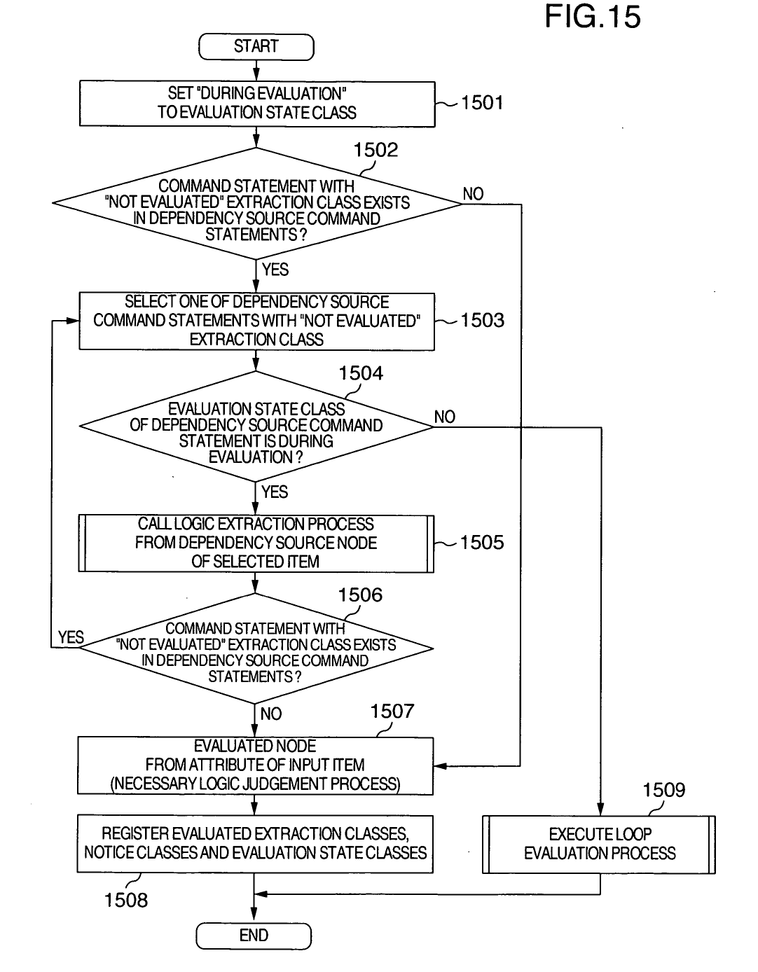

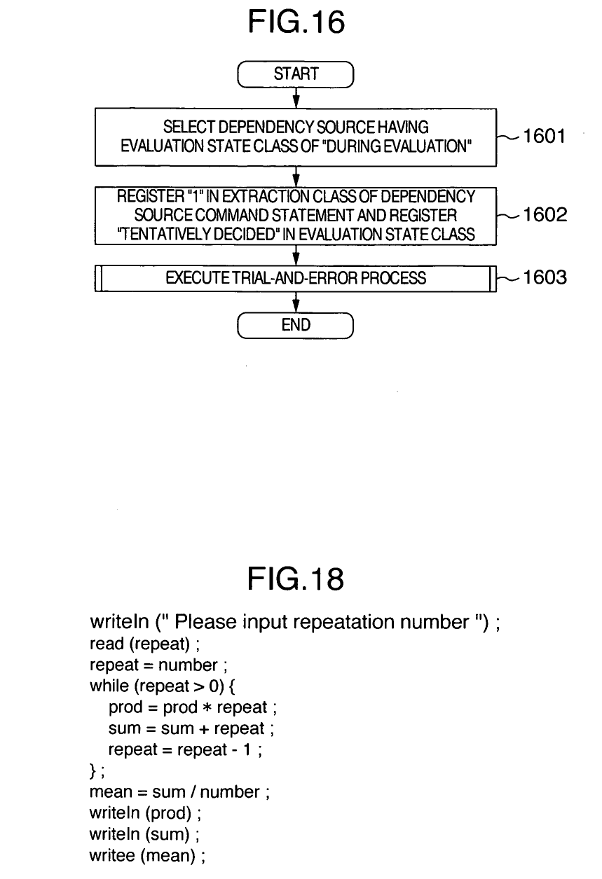

Flow charts shown in FIGS. 15 and 16 illustrate a method of extracting logic from a program containing a loop process. The fundamental process for a program with a loop is similar to that for a program without a loop, and is executed as shown in the flow chart of FIG. 3. However, the logic extraction process is different between an analysis subject program with a loop and an analysis subject program without a loop. This logic extraction process is shown as a subroutine of a loop evaluation process in the flow chart of FIG. 15. A process of evaluating a cut-out loop will be described with reference to FIGS. 16 and 17. In order to facilitate understanding of the description, the embodiment will be described after the description of the flow charts of FIGS. 15 to 17.

First, with reference to the flow charts of FIGS. 15 to 17, description will be made on the case that an analysis object program contains a loop process. Only different points from the flow chart for a program not containing a loop will be described for the flow chart of FIG. 15.

Three Steps 1501, 1504 and 1509 are different between an analysis subject program with a loop and an analysis subject program without a loop.

First, at Step 1501, “during evaluation” is registered in the evaluation state class of the command statement which called the logic extraction process.

If “during evaluation” is registered in the evaluation state class of the dependency source command statement at Step 1504, it is judged that dependency circulation is detected and the flow transits to Step 1509. In the loop evaluation process at Step 1509, the extraction classes of a set of command statements having dependency circulation are determined.

Next, description will be made on the loop evaluation process shown in FIG. 16.

First, the command statement having “during evaluation” registered in the extraction class of the command statement at Step 1504 is selected (Step 1601).

“1” is registered in the extraction class of the command statement selected at Step 1601, “tentatively decided” is registered in the evaluation state class, and “1” is registered in the trace start flag (Step 1602).

After the tentative value “1” is registered in the extraction class, a trial-and-error process shown in FIG. 17 is executed to decide the extraction class of the command statement having dependency circulation (Step 1603).

Next, description will be made on the trial-and-error process shown in FIG. 17.

First, it is confirmed whether “1” is registered in the trace start flag of the dependency source command statement, and if “1” is registered, the flow transits to Step 1705, whereas if not, the flow transits to Step 1702 (Step 1701).

If “1” is not registered in the trace start flag, the command statement having “during evaluation” or “tentatively decided” registered in the evaluation state class is selected from the dependency source command statements (Step 1702).

Next, the trial-and-error process is recursively called from the dependency source command statement selected at Step 1702 (Step 1703). The processes from Step 1701 to Step 1703 are executed for each dependency source command statement until the command statement having “1” registered in the trace start flag arrives. Therefore, the trial-and-error process is called from each command statement having dependency circulation.

If the trace start flag of “1” is registered in the dependency source command statement, the necessary logic judgement process 1705 is executed to evaluate the extraction class of the attended command statement (Step 1705).

Next, it is confirmed whether the trace start flag of “1” is registered in the command statement information table registering the evaluated command statement, and if registered, the flow transits to Step 1708 whereas if not, the flow transits to Step 1707 (Step 1706).

If it is judged at Step 1706 that “1” is not registered in the trace start flag, the evaluated extraction class, notice class, evaluation state class are registered in the command statement information table and word information table (Step 1707).

If it is judged at Step 1706 that “1” is registered in the trace start flag, it is confirmed whether the contents of the extraction class already tentatively decided are coincident with the result of the necessary logic judgement process 1705, and if coincident, the flow transits to Step 1709, whereas if not, the flow transits to Step 1710 (Step 1708).

If it is judged at Step 1708 that information on the extraction class already registered in the command statement information table is coincident with the result of the necessary logic judgement process, “decided” is registered in the evaluation state class of the attended command statement to thereafter terminate the trial-and-error process called from the attended command statement (Step 1709).

If it is judged at Step 1708 that information on the extraction class already registered in the command statement information table is not coincident with the result of the necessary logic judgement process, it is judged whether the tentative extraction class of the command statement having “1” registered in the trace start flag is “1”, and if “1” is registered in the extraction class, “3” is registered in the extraction class of the attended command statement, whereas if not, the flow transits to Step 1712 (Steps 1710 and 1711).

It is judged at Step 1712 whether the tentative extraction class of the command statement having “1” registered in the trace start flag is “3”, and if “3” is registered in the extraction class, “5” is registered in the extraction class of the, attended command statement at Step 1713, whereas if not, the flow transits to Step 1714 (Steps 1712 and 1713).

It is judged at Step 1714 whether the tentative extraction class of the command statement having “1” registered in the trace start flag is “5”, and if “5” is. registered in the extraction class, “2” is registered in the extraction class of the attended command statement at Step 1715 (Steps 1714 and 1715).

By executing the processes from Step 1710 to Step 1715, the extraction class coincident with the tentative extraction class of the command statement having “1” registered in the trace start flag is found, and “decided” is registered in the evaluation state class. In this manner, the extraction class of the command statement attended by the trial-and-error process called from each command statement having dependency circulation is evaluated to sequentially terminate the trial-and-error process.

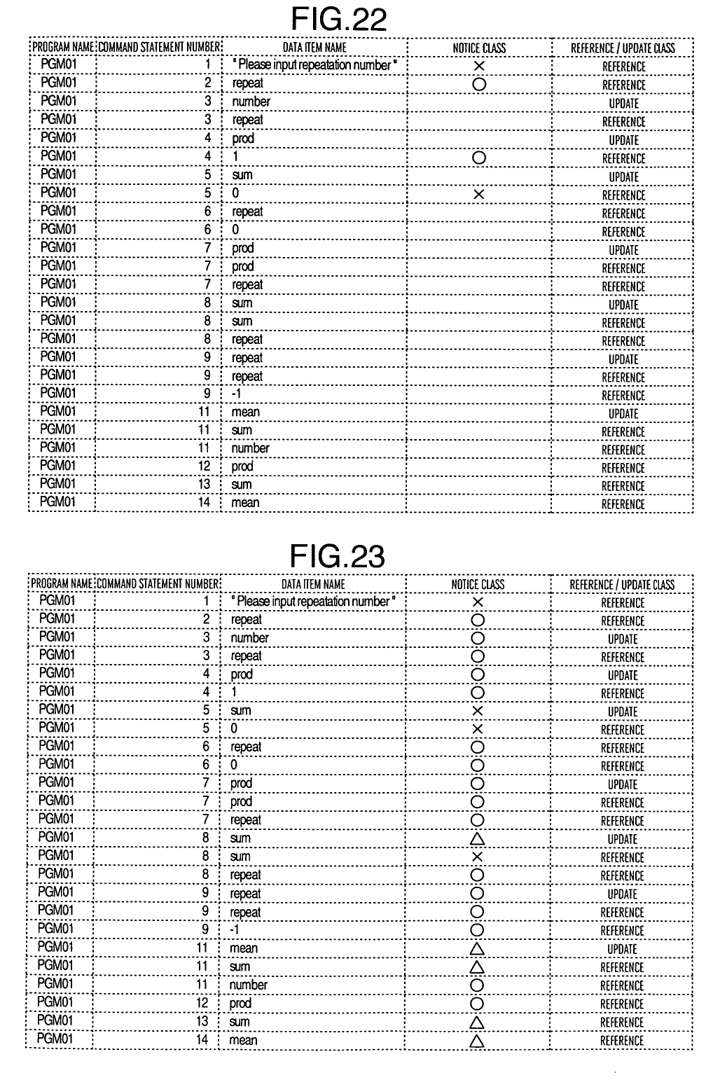

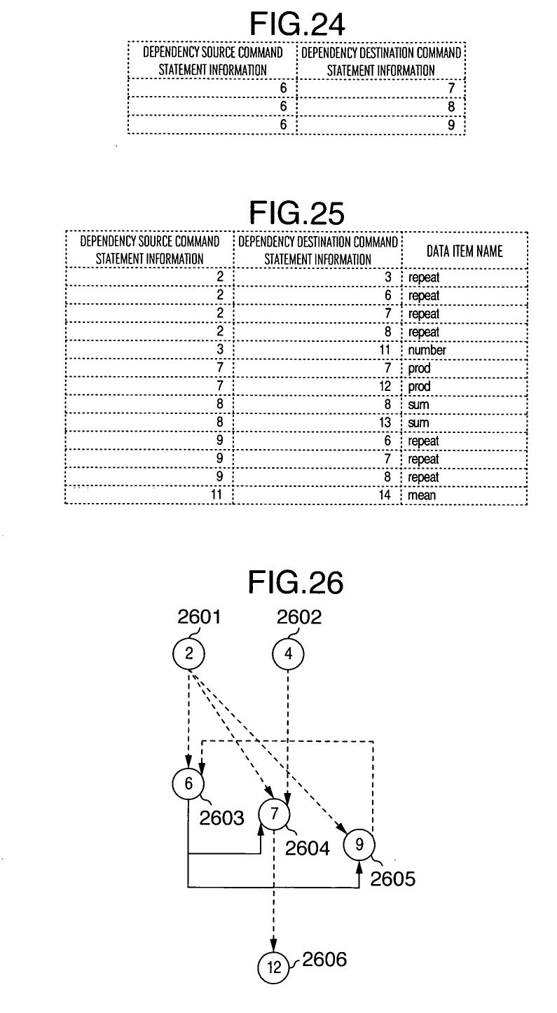

FIG. 18 shows an analysis subject program used in this embodiment. FIGS. 19, 22, 24 and 25 show a command statement information table, a word information table, a data dependency information table and a control dependency information table, respectively, before execution of the specific logic extraction function 203. FIG. 20 shows the command statement information table immediately before execution of the loop evaluation process during the specific logic extraction process. FIGS. 21 and 23 show the command statement information table and word information table after execution of the specific logic extraction function 203. In this embodiment, concrete description will be made on the method of extracting logic from a program containing a loop process, by taking as an example the process of analyzing the program shown in FIG. 17.

Concrete description will be made on the method of extracting logic from an analysis subject program containing a loop process, by taking as an example the dependency graph shown in FIG. 26. The dependency graph shown in FIG. 26 is formed by collecting command statements by which a command statement 2606 is influenced (it is sufficient that the graph is formed only by the collected command statements). In the system, dependency source information of the attended command statement is acquired from the control dependency information 603 and data dependency information 604 in the dependency information 112, and the notice class and extraction class of the attended command statement are evaluated. Since the function of each table has been described earlier, concrete description will be made by using the dependency graph of FIG. 26 formed by collecting the data dependency relation and control dependency relation between command statements.

First, as the command statement 2606 is designated as an output start point, “during evaluation” is registered in the evaluation state class of this command statement 2606 (Step 1501).

As the extraction class of the dependency source command statement is checked, it can be known that the extraction class of a command statement 2604 is not still evaluated so that the command statement 2604 is selected (Steps 1502 and 1503).

As the evaluation state class of the command statement 2604 is checked, it can be known that “during evaluation” is not registered so that the logic extraction process is recursively called from the command statement 2604 (Steps 1504 and 1505).

As the recursive call is repeated, it is judged at Step 1504 for the logic extraction process called from a command statement 2605 that “during evaluation” is registered in the evaluation state class of a dependency source command statement 2603. This is because dependency circulates between the command statements 2603 and 2605 as shown in the dependency graph of FIG. 26.

Since it is judged that “during evaluation” is registered in the evaluation state class of the dependence source command statement, the loop evaluation process shown in FIG. 16 is executed to evaluate the extraction class of the command statement having dependency circulation detected at Step 1504 and the notice class of the data item constituting the command statement (Step 1509).

Next, the loop evaluation process shown in FIG. 16 will be described by using the dependency graph of FIG. 26. First, as the command statement having the evaluation state class of “during evaluation” is searched from the dependency source command statements of the command statement 2605, the command statement 2603 is found and selected (Step 1601).

“1” is registered in the extraction class of the command statement 2603 selected at Step 1601, “tentatively decided” is registered in the evaluation state class, and “1” is registered in the trace start flag (Step 1602).

After the tentative extraction class of the command statement 2603 is decided, the trial-and-error process is executed to evaluate the extraction class of the command statement having dependency circulation (Step 1603).

Description will be made further on the trial-and-error process shown in FIG. 17 by using the dependency graph of FIG. 26.

It is judged whether there is a command statement having “1” registered in the trace start flag among dependency source command statements of the command statement 2603. Since there is no command statement having “1” registered in the trace start flag, the flow transits to Step 1702 (Step 1701).

Next, the command statement 2605 whose extraction class is still not evaluated is selected, and the trial-and-error process is recursively called from the command statement 2605 (Steps 1702 and 1703).

As the command statement having “1” registered in the trace start flag is checked among the dependency source command statements of the command statement 2605, it can be known that the command statement 2603 has “1” registered in the trace start flag. The extraction class of the command statement 2605 is evaluated by executing the necessary logic judgement process (Step 1705).

As the trace start flag of the command statement 2605 is checked, it can be known that “1” is not registered. Therefore, the evaluation result at Step 1705 is registered in the extraction class, “tentatively decided” is registered in the evaluation state class, and the trial-and-error process called from the command statement 2605 is terminated (Steps 1706 and 1709).

Since the trial-and-error process called from the command statement 2605 is terminated, the attended point transits to the trial-and-error process called from the command statement 2603. Since the process was stopped at Step 1703 for the command statement 2603, the process resumes from Step 1704. As the result of Step 1704, it can be known that all extraction classes of the dependency source command statements of the command statement 2603 are evaluated. Therefore, as the necessary logic judgement process is executed for the command statement 2603, the extraction class of the command statement 2603 is evaluated as “1” (Steps 1704 and 1705).

As the command statement 2603 is checked, it can be known that “1” is registered in the trace start flag and “1” is registered in the extraction class. As the result of the necessary logic judgement process at Step 1705, the notice class of the command statement 2503 is evaluated as “1” which is coincident with the already registered contents. Therefore, the contents of the evaluation state class are changed from “during evaluation” to “decided” to thereafter terminate the trial-and-error process called from the command statement 2603 (Steps 1706, 1708 and 1709).

In this embodiment, since the result of the necessary logic judgement process becomes coincident at Step 1708 with the already registered extraction class, Steps 1710 to 1715 are not described. If the extraction classes are not coincident at Step 1715, the tentative extraction class is determined in the order of “3”→“5”→“2” and the processes are repetitively executed until the result of the necessary logic judgement process becomes coincident with the tentative extraction class.

All trial-and-error processes called from respective command statements are completed in this manner, and the attended point transits to the command statement 2605 called the logic extraction process. Since the logic extraction process called from the command statement 2605 was stopped at Step 1509, the necessary logic judgement process at Step 1509 is executed and the result is registered. The result of the necessary logic judgement process indicates “1” for the extraction class and “decided” for the evaluation state class, and this result is registered to thereafter terminate the logic extraction process called from the logic 2605.

Similarly, the logic extraction process called from each command statement is sequentially terminated to thereby terminate a series of processes. The contents of the command statement information table and word information table at the end point are shown in FIGS. 21 and 23. (Logic display/correction function)

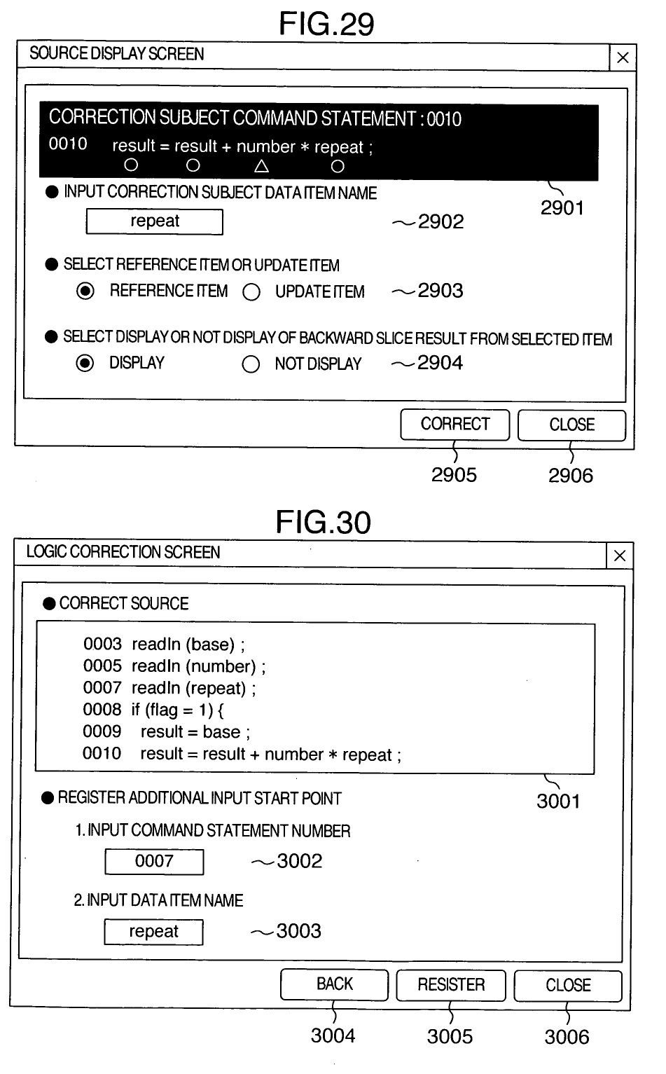

With reference to FIGS. 28 to 30, description will be made on the logic display/correction function which is the function of Step 204 in the flow chart of FIG. 2. First, an analysis subject program is displayed on a source display unit 2801. When the source is displayed, the extraction class is presented in the command statement unit, as logic extraction support information. A user is made to designate the command statement number of the command statement to be corrected and to depress a detailed display button 2804 to acquire the command statement number 2802 of the command statement to be corrected. The command statement to be corrected is displayed on a correction subject command statement display unit 2901. When this command statement is displayed, the notice class is presented in the data item, as correction support information. The command statements 2801 and data items 2901 may be distinguished by using different colors for each extraction class and notice class.

For a user who does not require the logic extraction support information in the data item unit, the user is made to depress a correction button 2803 to correct logic.

On the source display screen, a user is made to input a data item name in a field 2902 for the correction subject and select either the reference item or update item by a check button 2903 to uniquely decide the data item of the correction subject. If the result of the backward slice of the data item selected as the correction subject is to be checked and the command statement influenced by the data item is to be confirmed, “display” at 2904 is selected, whereas if not, “not display” is selected.

The user is made to input the above-described items and depress a correction button 2905 to thereafter transit to a logic correction screen shown in FIG. 30.

On the logic correction screen, command statements of the correction subject are displayed in a field 3001. If it is selected that the backward slice result is displayed at 2904, the result may be displayed in the field 3001 as the correction subject command statement.

If a user understands the display result and judges that an input start point is required to be additionally input, the start point is added to input fields 3002 and 3003.

A user is made to correct logic in this manner. If there is other corrections, the user is made to depress a return button 3004 to transit to the source display screen of FIG. 28. If correction is to be terminated, the user is made to depress a register button 3005 to register the correction results in the object program 111.

As described so far, it is possible to use the logic extraction support system of the present invention, in order to support the procedure of generating logic for calculating a user designated output from a user designated input.

It should be further understood by those skilled in the art that although the foregoing description has been made on embodiments of the invention, the invention is not limited thereto and various changes and modifications may be made without departing from the spirit of the invention and the scope of the appended claims.

1. A logic extraction support apparatus for supporting extraction of logic from a user designated program which logic is a set of command statements capable of being executed as a program, or correction of an extraction result, the apparatus comprising:
means for judging extraction necessity or correction necessity of each command statement or each data item contained in each command statement; and
means for outputting a judgement result.

2. The logic extraction support apparatus according to claim 1, further comprising means for outputting a set of command statements determined from a set of input items designated by a user, as a candidate for extraction subject logic.

3. The logic extraction support apparatus according to claim 1, wherein said judging means includes means for extracting as a command statement candidate to be corrected, a command statement influenced by both a variable determined from a set of input items designated by a user and a variable determined from a set of input items not designated by the user.

4. The logic extraction support apparatus according to claim 1, further comprising means for outputting in a distinguished manner a variable determined from a set of input items designated by a user and a variable determined from a set of input items not designated by the user.

5. The logic extraction support apparatus according to claim 1, wherein a variable determined from a set of input items not designated by a user is output as a logic candidate to be added to logic to be extracted or generated.

6. The logic extraction support apparatus according to claim 1, further comprising means for classifying and displaying the command statements and the data items in the program in accordance with a judgement result by said judging means.

7. The logic extraction support apparatus according to claim 6, wherein said classifying and displaying means displays a logic correction candidate portion, urging correction of sources, and if source correction is permitted, displaying again the logic correction candidate portion.

8. A logic extraction support method of supporting extraction of logic from a user designated program which logic is a set of command statements capable of being executed as a program, or correction of an extraction result, the method comprising steps of:
judging extraction necessity or correction necessity of each command statement or each data item contained in each command statement; and
outputting a judgement result.

9. The logic extraction support method according to claim 8, further comprising a step of outputting a set of command statements determined from a set of input items designated by a user, as a candidate for extraction subject logic.

10. The logic extraction support method according to claim 8, wherein said judging step includes a step of extracting as a command statement candidate to be corrected, a command statement influenced by both a variable determined from a set of input items designated by a user and a variable determined from a set of input items not designated by the user.

11. The logic extraction support. method according to claim 8, further comprising a step of outputting in a distinguished manner a variable determined from a set of input items designated by a user and a variable determined from a set of input items not designated by the user.

12. The logic extraction support method according to claim 8, wherein a variable determined from a set of input items not designated by a user is output as a logic candidate to be added to logic to be extracted or generated.

13. The logic extraction support method according to claim 8, further comprising a step of classifying and displaying the command statements and the data items in the program in accordance with a judgement result by said judging step.

14. A computer readable program for executing a logic extraction support method of supporting extraction of logic from a user designated program which logic is a set of command statements capable of being executed as a program running on a computer, or correction of an extraction result, the program comprising steps of:
judging extraction necessity or correction necessity of each command statement or each data item contained in each command statement; and
outputting a judgement result.

15. The program for executing a logic extraction support method according to claim 14, further comprising a step of outputting a set of command statements determined from a set of input items designated by a user, as a candidate for extraction subject logic.

16. The program for executing a logic extraction support method according to claim 14, wherein said judging step includes a step of extracting as a command statement candidate to be corrected, a command statement influenced by both a variable determined from a set of input items designated by a user and a variable determined from a set of input items not designated by the user.

17. The program for executing a logic extraction support method according to claim 14, further comprising a step of outputting in a distinguished manner a variable determined from a set of input items designated by a user and a variable determined from a set of input items not designated by the user.

18. The program for executing a logic extraction support method according to claim 14, wherein a variable determined from a set of input items not designated by a user is output as a logic candidate to be added to logic to be extracted or generated.

19. The logic extraction support method according to claim 14, further comprising a step of classifying and displaying the command statements and the data items in the program in accordance with a judgement result by said judging step.
